(19) United States
(12) Patent Application Publication
(10) Pub. No.: US 2025/0256493 A1
(43) Pub. Date: Aug. 14, 2025

(54) MULTI-LAYER METALLIZED PAPER-BASED PACKAGING MATERIAL

(71) Applicant: SOCIETE DES PRODUITS NESTLE S.A., Vevey (CH)

(72) Inventors: ABHIJIT BHATTACHARYA, Epalinges (CH); MARIE-AMELIE FRANCOISE SUZANNE GLERON, Vevey (CH); JENNI IRINA JUKARAINEN, Pully (CH); KARIM MISSOUM, Pusignan (FR); NICOLA GALAFFU, Ornex (FR); GERHARD NIEDERREITER, Vevey (CH)

(21) Appl. No.: 18/856,511

(22) PCT Filed: Apr. 12, 2023
(86) PCT No.: PCT/EP2023/059474

§ 371 Date: Oct. 11, 2024

(30) Foreign Application Priority Data
Apr. 14, 2022 (EP) 22168310.5

(51) Int. Cl. B32B 27/10; B32B 27/30; B32B 27/36

(52) U.S. Cl. CPC B32B 27/10; B32B 27/306; B32B 27/36; B32B 2250/03; B32B 2255/10; B32B 2255/205; B32B 2274/00; B32B 2307/7163; B32B 2307/7246; B32B 2553/00

(57) ABSTRACT

The present invention is directed to a multi-layer metallized paper-based packaging material (1) comprising, from its outer side to its inner side: —a paper layer (2) having a grammage comprised in the range of 40 to 120 g/m², —at least one first organic layer (3) of a biodegradable polymer selected within the list of: polyvinylalcohol (PVOH), butenediol vinyl alcohol co-polymer (BVOH), or a combination thereof, in an amount of 0.5 to 15 g/m², preferably in an amount of 1 to 10 g/m², —a vacuum deposited inorganic layer (4), comprising a metal, a metalloid, or a combination thereof, said inorganic layer having a thickness comprised between 1 and 100 nm, and—at least one second organic layer (5) made of a biodegradable polymer having tensile strength above 30 MPa and elongation at break above 850%, said second organic layer (5) being applied in an amount between 0.5 and 30 g/m², preferably in an amount between 1 to 10 g/m².

### FIELD OF THE INVENTION

The present invention relates to a multi-layer paper-based packaging material comprising a paper layer, an ultrathin metal or metalloid layer for water vapour barrier that is sandwiched between biodegradable polymeric thin layers that provide oxygen barrier and sealability to the structure. The resulting packaging material has a very high cellulose contents that provides recyclability, as well as, preferably, biodegradability in diverse environmental conditions.

### BACKGROUND OF THE INVENTION

Plastic packaging is used frequently in the economy and in people's daily lives. It has multiple advantages, such as its flexibility and its light weight. Such a weight reduction contributes to fuel saving and CO₂ reduction during transport, for example. Its barrier properties help to reduce food waste due a positive effect on increasing shelf life. The barrier properties also help to secure food safety.

However, with increasing environmental awareness, and in order to ensure that plastic waste is reduced, multilayer packaging materials have been developed which include a paper or cardboard layer, and one or several layers of plastic or metal films, which provide robustness as well as barrier properties, especially to oxygen and moisture.

In the most recent years, environmental awareness increased even further, in particular in relation to waste materials, for instance used packages, that are not recycled or treated properly, and contaminate oceans. This challenge is considered very seriously by industrials who spend increasingly extensive efforts to develop new packaging materials that are rapidly and easily biodegradable if accidentally thrown in nature, and in particular in a marine environment.

When manufacturing multilayer packaging material structures today, applying a layer of plastic by known techniques, in particular extrusion (extrusion-lamination), or similarly by an adhesive lamination process, necessarily provides a high thickness of the plastic film thus obtained onto the paper.

Even for relatively low thicknesses of extruded polymers in multilayer structures as described above, the cohesive strength of the polymer film is very high and the level of adhesion of the polymer to the paper or cardboard (i.e. cellulosic) substrate is also high. This prevents such polymer to detach from the substrate when recycled and prevents recycling and repulping of the cellulosic fiber portion in a paper-stream recycling process.

Therefore, later during the recycling process, the multilayer structure comprising a mixture of paper and plastic (polymer) films either extruded (by classic techniques as extrusion-lamination or extrusion coating) or adhesive-laminated, cannot be recycled in a paper-stream recycling process because the plastic layer is too thick to be dispersed and at the same time the same layer has cohesion strength and adhesion level to the adjacent layers of the structure, which are way too high to be separated from the other layers of materials, especially from the paper fibres. The extruded plastic film remains intact within the paper pulp bath, hence making it difficult to recycle paper pulp from the repulping process.

More than that, the recycling process of known laminated materials described above is expensive, and energy consuming and characterized with relatively low yield of paper fibres that are recycled (around 60% from the total amount of packaging materials in the entire structure), hence, not sufficiently environmentally friendly from a disposal and recycling perspective. There is also room for improving the recyclability of the rest of the packaging material (i.e. the plastic polymer and the metal parts, e.g. aluminium parts) in a paper recycling stream.

Furthermore, for packaging intended for food products, good barrier properties are essential for maintaining the safety and quality of packaged foods. Typically, such barrier properties include gas barrier, for example to oxygen and water vapor (moisture), and if possible, also, liquid tightness.

One way to provide good moisture barrier in paper-based packaging materials, is the introduction of a metal or metalloid layer in a so-called “metallized” layer. In the present description, the word “metallized” (for instance in the expression “metallized barrier paper layer”) is meant to encompass the deposition at the surface of paper or paperboard, of metal or metalloid atoms. One can even consider embodiments comprising the deposition of an alloy of metal and metalloid. Metalloids are close to metals in some of their characteristics. Aluminium oxide and silicon oxide are examples of metalloids.

Problematic with the introduction of a metal layer in paper-based packaging material is the sensitivity of the metal layer to mechanical stress as well as poor adhesion of metal to paper surface, poor smoothness and high porosity of paper materials. Mechanical stress can—for example—easily result in a loss of the required barrier properties that the metallized packaging material should provide. This may be due to the processing of the multilayer material during manufacturing of package using a form-fill-seal packaging machine, whereby said material is stretched, bent, rolled, compressed and/or heated during forming and sealing of packages by conventional packaging forming methods. Such packaging manufacturing processes cause high mechanical and or chemical stress to the material and in particular to the ultrathin metallized layer of metal or metalloid, and therefore leads to damaging such layers, creating cracks and tears.

Having considered the above, there is a need for a multi-layer metallized paper-based packaging material that exhibits simultaneously:
sufficient barrier properties, in particular to oxygen and moisture,
a high resilience to mechanical stress, such that it keeps the same level of barrier even when subjected to transformation processes such as the ones used for manufacturing packages,
a greatly reduced amount of plastic polymer contents compared to the content of cellulosic material,
and also preferably recyclability in the paper stream and/or biodegradability in diverse environmental conditions especially (but not only) in a marine environment.

### SUMMARY OF THE INVENTION

The objective of the present invention is achieved with a multi-layer metallized paper-based packaging material comprising, from its outer side to its inner side:
a paper layer having a grammage comprised in the range of 40 to 120 g/m²,
at least one first organic layer (3) of a biodegradable polymer or copolymer selected within the list of: polyvinylalcohol (PVOH), ethylene vinyl alcohol (EVOH), butenediol vinyl alcohol co-polymer (BVOH), or a combination thereof, in an amount of 0.5 to 15 g/m², preferably in an amount of 1 to 10 g/m²,
a vacuum deposited or transfer metallized inorganic layer, comprising a metal, a metalloid, or a combination thereof, said inorganic layer having a thickness comprised between 1 and 100 nm, and
at least one second organic layer made of a biodegradable polymer having tensile strength above 30 MPa and elongation at break above 850%, said second organic layer being applied in an amount between 0.5 and 30 g/m², preferably in an amount between 1 to 10 g/m².

The overall thickness of polymer coating layers in the structure is extremely reduced compared to the thickness of paper material, therefore the inventors have achieved to overcome the technical limitations of the known multilayer barrier structures, and achieve a packaging multilayer structure with excellent barrier properties against oxygen and moisture transfer, as well as resistance to liquid contact from their inner or outer surfaces, while achieving a total contents of cellulosic fibres comprised preferably up to 95% of the overall material weight.

Furthermore, pre-coating polymer layer being water soluble promotes recyclability. The fact that the inventors succeeded in forming a multilayer structure completely deprived of polymer layers formed by extrusion lamination and/or adhesive lamination, provides a multilayer structure with a ratio of cellulosic fibre to non-cellulosic material, which is extremely high in fibre contents, and wherein the polymer layers are easy to disintegrate in repulping process due to the solubility of precoating layer in water, and also the relatively low adhesion of the post-metallization (or post-metalloidization) polymer to the rest of the metallized layer. The resulting structure therefore demonstrates excellent repulping capabilities and high fibre yield which allows it to be accepted in paper waste collection in the most countries. The very low content of non-cellulosic polymer and vacuum-deposited metal materials, makes the whole material of the invention easily disintegrated, dissolved and separated during recycling processes designed for cellulosic materials like paper or cardboard, unlike existing multi-layer barrier structures known from the art.

In a highly preferred embodiment of the invention, the biodegradable polymer used for said second organic layer is selected within the list of: a polycaprolactone (PCL), a thermoplastic starch (TPS), or polybutylene adipate terephthalate (PBAT).

Amongst those three, polycaprolactone (PCL) is preferred for its mechanical, heat-sealing and biodegradability properties.

Advantageously but not necessarily, the first organic layer further can comprise a mineral filler selected within the list of: kaolin, calcium carbonate, talc, silica, wollastonite, clay, calcium sulfate fibers (also known as Franklin fiber), mica, glass beads, alumina trihydrate, and combinations thereof.

The inorganic layer is preferably selected within the list of: a metal, especially aluminium, or a metalloid, in particular aluminium oxide (AIOx), silicon oxide (SiOx). The inorganic layer can also be made of an alloy thereof.

In one embodiment of the invention, the multilayer material structure further comprises a third organic layer coated on the inner side of second organic layer, said third layer comprising a biodegradable polymer selected within the list of: polybutylene succinate-co-butylene adipate (PBSA) or polyhydroxyalkanoates (PHA) based polymer in an amount in the range of about 0.5-30 g/m², preferably in the range of 1 to 15 g/m².

The organic layers are preferably applied either as an aqueous solution or dispersion, or by extrusion of an ultrathin layer having a thickness lower than 30 g/m², preferably lower than 15 g/m².

The packaging material according to the invention is recyclable as paper and/or carton, and it preferably achieves high barrier properties, as follows: a Water Vapour Transmission Rate (WVTR) below 1 g/m²/day (measured at 23° C., 85% Relative Humidity) and/or an Oxygen Transmission Rate (OTR) below 3 cm³/m²/day bar (measured at 23° C., 50% RH) after folding the material to 180° under 2 kilograms of compressive load in such a manner that the coating side of the paper is under compressive stress during folding.

Furthermore, the packaging material of the invention advantageously has a strain at break under in-plane tensile loading up to 4% in machine direction and up to 10% in the cross-machine direction of the paper.

The present invention is further directed to a tridimensional closed packaging item made of a multi-layer metallized paper-based packaging material as described before, which is obtained by forming, then filling with an edible product for human or animal consumption, and then sealing said packaging material.

The present invention is further directed to the use of a multi-layer metallized paper-based packaging material described before, for packing an edible product for human or animal consumption.

The present invention is further directed to a packaged edible product, comprising a multi-layer metallized paper-based packaging material per the invention, which is filled with an edible product for food or animal consumption.

Preferably, said edible product is a powder, a gel, or kibbles and is selected within the list of: soluble coffee, nutrition compositions for infant, adult, or elderly consumption, soup, confectionery or candies, chocolate-based products, dry animal food.

As used in this specification, the words “comprises”, “comprising”, and similar words, are not to be interpreted in an exclusive or exhaustive sense. In other words, they are intended to mean “including, but not limited to”.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 shows a first embodiment of a multilayer structure according to the invention;

FIG. 2 shows a second embodiment of a multilayer structure according to the invention.

### DETAILED DESCRIPTION OF THE INVENTION

Generally, in the present specification, “extrusion coating”, it is meant a method to provide a layer of polymer by using an extruder which forces melted thermoplastic resin (e.g. polyethylene) through a horizontal slot-die onto a moving web of substrate (e.g. paper). The resulting product is a permanently coated web structure.

By “extrusion lamination”, it is meant a similar process to extrusion coating, whereby a polymer resin is extruded between two substrates (e.g. a layer of paper and another layer of polymeric film), and acts as a bonding agent.

By “adhesive lamination”, it is meant a process whereby one paper material is coated with adhesive and laminated to a second paper or paperboard material.

In a lamination process, two thick layers of material are combined, either by extrusive lamination or adhesive lamination, whereby the thickness of each layer is far greater than the thickness obtained by dispersion coating.

By “dispersion coating”, it is meant a coating technique whereby an aqueous dispersion of fine polymer particles or polymer solution is applied to the surface of paper or board as such, in order to form a solid, non-porous film after drying. Dispersion coating can be performed by gravure, flexo-gravure, rod, blade, slot-die, curtain air knife, or any other known method of paper coating. Dispersion coating can create a much thinner layer than extrusion lamination and/or adhesive lamination, since the polymer is mixed in an aqueous water solution. This brings advantages in terms of quantity of polymer usage, its barrier performance and recyclability of resulting paper structure. The target of dispersion coating is to achieve a barrier layer against water, water vapour, grease, oil, gas, etc. by environmentally friendly coating. Another target is to prepare surface of paper material for a vacuum deposition process.

In all possible embodiments of the invention, and especially in the exemplary embodiments described specifically hereafter, the multilayer packaging structure is preferably biodegradable in a soil or marine environment. Such a preferred biodegradability can be achieved when the structure contains a cellulosic base, an ultrathin inorganic layer that contains only a few atoms of metal or metalloid per square meter, and also because all polymeric components are biodegradable polymers.

Biodegradability of the final structure is defined and tested under international standard ISO 22403 (“Assessment of the intrinsic biodegradability of materials exposed to marine inocula under mesophilic aerobic laboratory conditions”).

In addition to, or alternatively to, its intrinsic biodegradability properties, the multilayer structure according to the invention is also preferably designed to qualify for being as well recyclable in a paper stream process.

Recyclability in the paper stream is achieved by multilayer structure of the invention wherein:
cellulose contents is predominant relatively to all the ingredients contained therein (the definition of recyclability in the paper stream depends on national legislations but in average, it is required that the material contains at least 80% cellulose to be accepted in a recycling process dedicated to paper), and
the inorganic layer is ultrathin (i.e. a few nanometres, typically between 1 and 50 nm) and its thickness is constituted of a few atoms,
organic polymer layers are all deposited by coating, which means that the layers thus obtained are sufficiently thin in relation to paper thickness to achieve an extremely high paper contents of the overall structure,
pre-metallization layer (or pre-metalloidization), i.e. first organic layer comprises a polymer being water soluble, which makes it easier to separate the fiber from the rest of the structure, in particular from the cellulosic contents,
and finally, the subsequent organic layers (second organic layer, third, etc.), that are deposited on the inner side of the metallic or metalloid layer, feature low cohesion and low adhesion with the rest of the structure components, which makes the whole structure compatible with paper recycling processes as explained herein before.

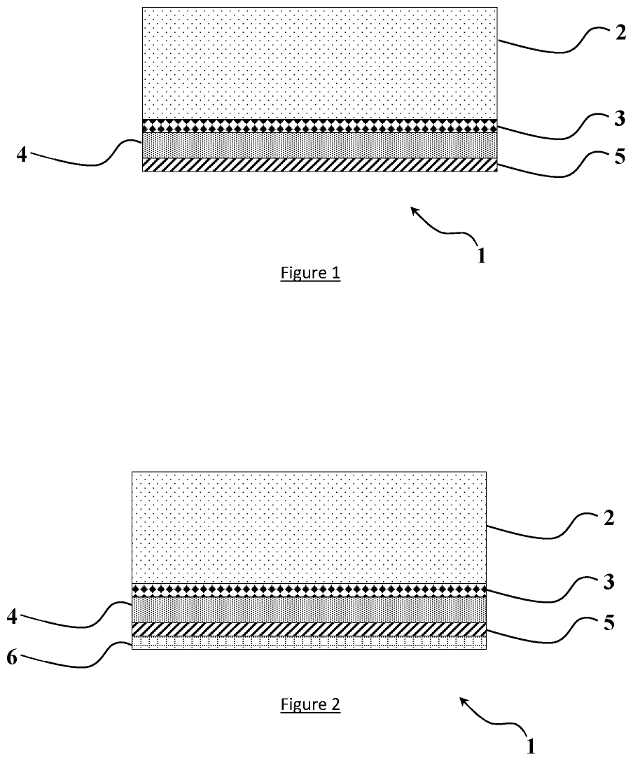

In FIG. 1 is illustrated a first embodiment of the invention. In this embodiment, the multilayer structure 1 comprises in order, from its outer side towards its inner side (i.e. the inner side in contact with the packaged product):
a highly smooth paper layer 2 of grammage 62 g/m²,
a first organic polyvinyl alcohol-based (PVOH) pre-metallization coating layer 3 that provides mainly gas (esp. oxygen) barrier properties and is applied as an aqueous solution in weight of 3 g/m²,
an inorganic vacuum deposited layer 4 of aluminium having a thickness of 40 nm, which provides mainly moisture vapour barrier properties, and
a second organic coating layer 5 of polycaprolactone (PCL) that is applied as an aqueous dispersion in weight of 5 g/m².

The innermost polycaprolactone layer 5 functions as a heat sealable layer in this first embodiment.

The inorganic layer 4 of aluminium can be deposited by a direct metallization process, or by a transfer metallization process.

In this embodiment, the first and second organic layers are applied by aqueous dispersion coating technique, which allows to improve their recyclability in a paper stream process.

The structure 1 of this first embodiment achieves high moisture and gas barrier properties with values of Oxygen Transmission Rate (OTR) below 0.5 cm³/m²/day measured at 23° C. and 50% relative humidity (RH), and water vapour transmission rate (WVTR) below 0.5 g/m²/day measured at 38° C. and 85% RH.

The tensile strength of the polycaprolactone polymer used for the PCL layer 5, is measured in standard test conditions (DIN EN ISO 527-1) at 33 MPa, and its elongation at break is measured at 910%. These values provide excellent resilience properties which allow to protect the aluminium layer during processing of the structure in conventional packaging forming processes. No cracking of the aluminium layer is generated during bending, stretching and/or sealing of the material when manufacturing a package out of it, which results in maintaining the level of OTR and WVTR barrier properties equivalent before and after a package is formed from the multilayer structure material.

As an alternative in this first embodiment, the innermost PCL dispersion coating heat-seal layer can be replaced by a thermoplastic starch (TPS) or polybutylene adipate terephthalate (PBAT) heat seal layer having a thickness of 9 gsm, applied by aqueous dispersion coating.

The tensile strength of the TPS polymer used alternatively to the PCL, is measured in standard test conditions (DIN EN ISO 527-1) at 29 MPa, and its elongation at break is measured at 1000%.

If PBAT is used as an alternative polymer to PCL, the polymer used in this case has a tensile strength measured at 40 MPa and its elongation at break is 1120%.

In FIG. 2 is depicted a second embodiment of a paper-based barrier multilayer packaging structure 1 according to the invention.

In this second embodiment, the multilayer structure comprises in order, from its outer side towards its inner side (i.e. the inner side in contact with the packaged product):
a highly smooth paper layer 2 of grammage 62 g/m²,
a first organic coating layer 3 of PVOH that is applied as an aqueous solution in an amount of 3 g/m², then
a vacuum-deposited inorganic (aluminium) layer 4 of thickness 40 nm.

Then, a second organic layer 5 of polycaprolactone (PCL) polymer is applied as a first post-metallization on the inner side of the inorganic layer 4, as an aqueous dispersion in an amount of 5 g/m².

And then, a third organic layer 6 of Polybutylene Succinate-co-Butylene Adipate (PBSA) polymer is applied onto the inner side of the second organic layer 5, which fulfils the role of a second post-metallization layer. It is applied as an extrusion coating, in an amount of 8 g/m².

The second organic layer 5 of PCL functions as a tie layer between the inorganic layer 4 and the third organic layer 6 of PBSA. The innermost PBSA based coating layer 6 functions as heat sealable layer in this second embodiment of the invention.

Like in the first embodiment, alternative polymers to PCL can be envisaged, provided that there resilience characteristics (tensile strength, elongation at break) correspond to the requirements set out for working the invention. For instance, PCL can be replaced by TPS or PBAT polymers that feature tensile strength values above 30 MPa and elongation at break above 850%.

As an alternative third embodiment, in the third organic heat-seal layer 6, PBSA can be replaced by a polyhydroxyalcanoate (PHA) also having a thickness of 8 gsm.

The structures corresponding to the above-described embodiments fulfil the requirements for biodegradability of the material or a packaging made thereof, in standard conditions.

In all of the embodiments of the invention described above, the multilayer structure can comprise other additional and optional layers not described in full details therein. Such layers can comprise for instance a print layer on the outer surface of the paper layer, as well as optionally a protective layer that is deposited on the external side of the print layer, and therefore constitutes the outermost layer of the whole structure. Print and optional protective layers are not described in more detail because they are known technology to the skilled person.

In all embodiments of the invention, technical parameters such as grammage, tensile strength, elongation at break and strain at break for instance, can be determined by the skilled person according to standard methods which are widely used and known in the art. It is therefore not necessary to provide further details about these standard measurement methods, or the equipment that is necessary to practice such methods. Examples of such standard methods are as follows: for measuring “grammage” the standard method is based on ISO 536:2019 standard, for measuring the “elongation at break” the standard method is based on ISO 1924-2:2008, for measuring the “tensile strength” the standard method is based on ISO 1924-2:2008, and for “strain at break” the method of measurement is based on the same standard as the one used for measuring elongation at Break (i.e. ISO 1924-2:2008).

1. A multi-layer metallized paper-based packaging material comprising, from its outer side to its inner side:
a paper layer having a grammage comprised in the range of 40 to 120 g/m²,
at least one first organic layer of a biodegradable polymer or copolymer selected from the group consisting of: polyvinylalcohol (PVOH), ethylene vinyl alcohol (EVOH), butenediol vinyl alcohol co-polymer (BVOH), and combinations thereof, in an amount of 0.5 to 15 g/m²,
a vacuum deposited, or transfer metallized inorganic layer, comprising a material from the group consisting of metal, a metalloid, and combinations thereof, said inorganic layer having a thickness comprised between 1 and 100 nm, and
at least one second organic layer made of a biodegradable polymer having tensile strength above 30 MPa and elongation at break above 850%, said second organic layer being applied in an amount between 0.5 and 30 g/m².

2. The multi-layer metallized paper-based packaging material according to claim 1, wherein the biodegradable polymer used for said second organic layer is selected from the group consisting of: a polycaprolactone (PCL), a thermoplastic starch (TPS), or polybutylene adipate terephthalate (PBAT).

3. The multi-layer metallized paper-based packaging material according to claim 1, wherein the first organic layer further comprises a mineral filler selected from the group consisting of: kaolin, calcium carbonate, talc, silica, wollastonite, clay, calcium sulfate fibers (also known as Franklin fiber), mica, glass beads, alumina trihydrate, and combinations thereof.

4. The multi-layer metallized paper-based packaging material according to claim 1, wherein the metal or metalloid inorganic layer is selected from the group consisting of: aluminium, aluminium oxide (AlOx), silicon oxide (SiOx), and an alloy thereof.

5. The multi-layer metallized paper-based packaging material according to claim 1, which further comprises a third organic layer coated on the inner side of second organic layer, said third layer comprising a biodegradable polymer selected from the group consisting of: polybutylene succinate-co-butylene adipate (PBSA) or polyhydroxyalkanoates (PHA) based polymer in an amount in the range of about 0.5-30 g/m².

6. The multi-layer metallized paper-based packaging material according to claim 1, wherein the organic layers are applied either as an aqueous solution or dispersion, or by extrusion of an ultrathin layer having a thickness lower than 30 g/m².

7. The multi-layer metallized paper-based packaging material in accordance with claim 1, wherein the packaging material is recyclable as paper and/or carton.

8. The multi-layer metallized paper-based packaging material according to claim 1, wherein the packaging material has a Water Vapour Transmission Rate (WVTR) below 1 g/m²/day (measured at 23° C., 85% Relative Humidity) and/or an Oxygen Transmission Rate (OTR) below 3 cm³/m²/day bar (measured at 23° C., 50% RH) after folding the material to 180° under 2 kilograms of compressive load in such a manner that the coating side of the paper is under compressive stress during folding.

9. The multi-layer metallized paper-based packaging material according to claim 1, wherein the packaging material has a strain at break under in-plane tensile loading up to 4% in machine direction and up to 10% in the cross-machine direction of the paper.

10. A tridimensional closed packaging item made of a multi-layer metallized paper-based packaging material comprising, from its outer side to its inner side:
a paper layer having a grammage comprised in the range of 40 to 120 g/m²,
at least one first organic layer of a biodegradable polymer or copolymer selected from the group consisting of: polyvinylalcohol (PVOH), ethylene vinyl alcohol (EVOH), butenediol vinyl alcohol co-polymer (BVOH), and combinations thereof, in an amount of 0.5 to 15 g/m²,
a vacuum deposited, or transfer metallized inorganic layer, comprising a material from the group consisting of metal, a metalloid, and combinations thereof, said inorganic layer having a thickness comprised between 1 and 100 nm, and
at least one second organic layer made of a biodegradable polymer having tensile strength above 30 MPa and elongation at break above 850%, said second organic layer being applied in an amount between 0.5 and 30 g/m², which is obtained by forming, filling with an edible product for human or animal consumption, and then sealing said packaging material.

11. (canceled)

12. A packaged edible product, comprising a multi-layer metallized paper-based packaging material comprising, from its outer side to its inner side:
a paper layer having a grammage comprised in the range of 40 to 120 g/m²,
at least one first organic layer of a biodegradable polymer or copolymer selected from the group consisting of: polyvinylalcohol (PVOH), ethylene vinyl alcohol (EVOH), butenediol vinyl alcohol co-polymer (BVOH), and combinations thereof, in an amount of 0.5 to 15 g/m²,
a vacuum deposited, or transfer metallized inorganic layer, comprising a material from the group consisting of metal, a metalloid, and combinations thereof, said inorganic layer having a thickness comprised between 1 and 100 nm, and
at least one second organic layer made of a biodegradable polymer having tensile strength above 30 MPa and elongation at break above 850%, said second organic layer being applied in an amount between 0.5 and 30 g/m², filled with an edible product for food or animal consumption.

13. A packaged edible product according to claim 12, wherein said edible product is a powder, a gel, or kibbles and is selected from the group consisting of: soluble coffee, nutrition compositions for infant, adult, or elderly consumption, soup, confectionery and candies, chocolate-based products, dry animal food.
